(19) United States
(12) Patent Application Publication
(10) Pub. No.: US 2008/0026756 A1
(43) Pub. Date: Jan. 31, 2008

(54) METHOD AND APPARATUS FOR SELECTING A TIMING OF A CELL RESELECTION IN A WIRELESS COMMUNICATION SYSTEM

(75) Inventors: John M. Harris, Glenview, IL (US); Ajoy K. Singh, Round Lake, IL (US); Stavros Tzavidas, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/780,263

(22) Filed: Jul. 19, 2007

Related U.S. Application Data
(60) Provisional application No. 60/833,621, filed on Jul. 27, 2006.

(51) Int. Cl. H04Q 7/20

(52) U.S. Cl. 455/436

(57) ABSTRACT

A wireless communication system that implements cell reselections selects a timing of a cell reselection in association with a mobile station (MS) by transferring, by a layer at least as high as Layer 3 to a cell reselection decision function residing in a layer lower than Layer 3, information indicating whether a present time is a more favorable time or a less favorable time for a cell reselection and initiating, by the cell reselection decision function, a cell reselection at a time based on the information received from the layer at least as high as Layer 3. In another embodiment of the invention, the transferred information may instead, or in addition, indicate a future time at which to perform a cell reselection. By selectively timing a cell reselection, an impact of a cell reselection on an application being executed by the MS is minimized.

### CROSS-REFERENCE TO RELATED APPLICATION

This application claims priority from provisional application Ser. No. 60/833,621, entitled “METHOD AND APPARATUS FOR SELECTING A TIMING OF A CELL RESELECTION IN A WIRELESS COMMUNICATION SYSTEM,” filed Jul. 27, 2006, which is commonly owned and incorporated herein by reference in its entirety.

### FIELD OF THE INVENTION

The present invention relates generally to wireless communication systems, and, in particular, to cell reselection in a wireless communication system.

### BACKGROUND OF THE INVENTION

As a mobile station (MS) operates in a wireless communication system, the MS may experience deterioration in radio frequency (RF) signal conditions or congestion conditions with respect to the communication services provided to the MS by a source base station of a wireless infrastructure. As a result, the MS may decide to perform a cell reselection. During cell reselection, the MS decides to abandon the source cell, that is, the cell serviced by the source base station, and to move to a neighboring, or target, cell, such as a cell serviced by a target base station.

Cell reselections can have a negative impact on application performance and can cause a degradation in user experience. For example, in a break before make handover, there is a period of time when no data is being sent to the MS. By way of another example, in the course of a cell reselection procedure, a significant period of time may elapse after the MS establishes a communication link with a target base station and before a data node detects that the MS has performed a cell reselection. In the meanwhile, the data node may continue sending data packets to the source base station, and via the source base station, to the MS, while the MS has ceased listening to a traffic channel associated with the source base station. As a result, the MS does not receive the data packets conveyed to the source base station subsequent to the MS establishing the communication link with the target base station and such data packets must be reconveyed to the MS via the target base station.

When a user of the MS is executing a time sensitive application, these breaks and delays in data transmissions may have a detrimental impact on the user's experience. For example, such delays may be particularly undesirable when the user is mid-word or mid-sentence during a telephone call or a push-to-talk call, when the user is engaged in a video game via an air interface and the action is immediate, for example, when a ball is near a goal or the user is engaged in heavy combat or a tricky driving scenario, or when the user is engaged in a multi-user video game with another remote gamer and the game involves motion or visual activity. Any delay in data transfer at such moments may frustrate the user and create user dissatisfaction with the application or the service provider.

Therefore, a need exists for a method and apparatus that selects an optimal time for a cell reselection, thereby minimizing the impact of the cell reselection on the user's experience.

### BRIEF DESCRIPTION OF THE DRAWINGS

FIG. 1 is a block diagram of a wireless communication system in accordance with an embodiment of the present invention.

FIG. 2 is a block diagram of mobile station of FIG. 1 in accordance with an embodiment of the present invention.

FIG. 3 is a block diagram of a network element of FIG. 1 in accordance with an embodiment of the present invention.

FIG. 4 is a block diagram of a protocol stack implemented in one or more elements of the network of FIG. 1 and in the mobile station of FIG. 1 in accordance with an embodiment of the present invention.

FIG. 5 is a logic flow diagram depicting a selecting of a timing of a cell reselection in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

To address the need for a method and an apparatus that selects an optimal time for a cell reselection, thereby minimizing the impact of the cell reselection on the user's experience, a wireless communication system that implements cell reselections selects a timing of a cell reselection in association with a mobile station (MS) by transferring, by a layer at least as high as Layer 3 to a cell reselection decision function residing in a layer lower than Layer 3, information indicating whether a present time is a more favorable time or a less favorable time for a cell reselection and initiating, by the cell reselection decision function, a cell reselection at a time based on the information received from the layer at least as high as Layer 3. In another embodiment of the invention, the transferred information may instead, or in addition, indicate a future time at which to perform a cell reselection. By selectively timing a cell reselection, an impact of a cell reselection on an application being executed by the MS is minimized and potential user dissatisfaction due to interruptions in the execution of the application is reduced.

Generally, an embodiment of the present invention encompasses a method for selecting a timing of a cell reselection in association with a mobile station. The method includes transferring, by a layer at least as high as Layer 3 to a cell reselection decision function residing in a layer lower than Layer 3, information indicating whether a present time is a more favorable time or a less favorable time for a cell reselection and initiating, by the cell reselection decision function, a cell reselection at a time based on the information received from the layer at least as high as Layer 3.

Another embodiment of the present invention encompasses a method for selecting a timing of a cell reselection. The method includes transferring, by a layer at least as high as Layer 3 to a cell reselection decision function residing in a layer lower than Layer 3, information comprising an indication of a future time at which to perform a cell reselection and initiating, by the cell reselection decision function, a cell reselection at a time based on the information received from the layer at least as high as Layer 3.

Yet another embodiment of the present invention encompasses a mobile station comprising a processor that is configured to transfer, by a layer at least as high as Layer 3 to a cell reselection decision function residing in a layer lower than Layer 3, information indicating whether a present time is a more favorable time or a less favorable time for a cell reselection and to initiate, by the cell reselection decision function, a cell reselection at a time based on the information received from the layer at least as high as Layer 3.

Still another embodiment of the present invention encompasses a mobile station comprising a processor that is configured to transfer, by a layer at least as high as Layer 3 to a cell reselection decision function residing in a layer lower than Layer 3, information comprising an indication of a future time at which to perform a cell reselection and initiate, by the cell reselection decision function, a cell reselection at a time based on the information received from the layer at least as high as Layer 3.

Yet another embodiment of the present invention encompasses a network element comprising a processor that is configured to transfer, by a layer at least as high as Layer 3 to a cell reselection decision function residing in a layer lower than Layer 3, information indicating whether a present time is a more favorable time or a less favorable time for a cell reselection by a mobile station and to initiate, by the cell reselection decision function, a cell reselection at a time based on the information received from the layer at least as high as Layer 3.

Still another embodiment of the present invention encompasses a network element comprising a processor that is configured to transfer, by a layer at least as high as Layer 3 to a cell reselection decision function residing in a layer lower than Layer 3, information comprising an indication of a future time at which to perform a cell reselection and initiate, by the cell reselection decision function, a cell reselection at a time based on the information received from the layer at least as high as Layer 3.

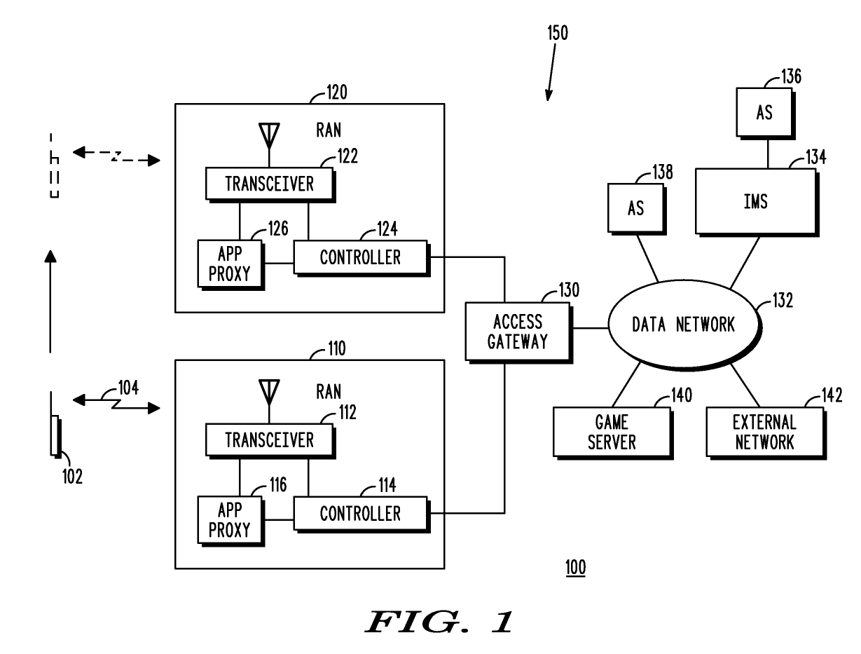

The present invention may be more fully described with reference to FIGS. 1-5. FIG. 1 is a block diagram of a wireless communication system 100 in accordance with an embodiment of the present invention. Communication system 100 includes multiple radio access networks (RANs) 110, 120 (two shown). Each radio access network (RAN) 110, 120, includes a respective transceiver 112, 122, such as a base transceiver station (BTS), a Node B, or an access point, that is operably coupled to, or that includes, a respective controller 114, 124, such as a base station controller (BSC) or a radio network controller (RNC). Each RAN 110, 120 may further include a respective application proxy 116, 126 that is coupled to the transceiver and the controller of the RAN. Communication system 100 further includes an access gateway 130 that is coupled to each of the multiple RANs 110, 120. Access gateway 130 is a gateway, such as a radio network controller (RNC), a mobile switching center (MSC), a packet data service node (PDSN), a media gateway, or a gateway router, via which each RAN 110, 120 may access a data network 132. However, in another embodiment of the present invention, each RAN 110, 120 may access data network 132 via a separate access gateway. In still other embodiments of the present invention, each of the multiple RANs 110, 120 may be associated with a different access gateway and may further each be associated with an air interface technology different from the air interface technology associated with the other RANs.

Communication system 100 further includes one or more application servers (ASs) 136, 138 (two shown), a game server 140, an external network 142, and an Internet Protocol (IP) Multimedia Core Network Subsystem (IMS) 134 that may each be accessed by RANs 110, 120 via access gateway 130. As is known in the art, IMS 134 comprises multiple network elements (not shown), such as an interrogating call session control function (I-CSCF), a serving call session control function (S-CSCF), a home subscriber server (HSS), network domain selection (NeDS) functionality, a call continuity control function (CCCF), and a home location register (HLR). In addition, communication system 100 includes a mobile station (MS) 102, such as but not limited to a cellular telephone, a radio telephone, a personal digital assistant (PDA) with radio frequency (RF) capabilities, a gaming device with an RF interface, or a wireless modem that provides RF access to digital terminal equipment (DTE) such as a laptop computer. Preferably MS 102 comprises a hybrid MS that is capable of supporting multiple air interface technologies.

MS 102 is provided communication services by a source RAN, that is, RAN 110, which RAN services a source cell in which the MS resides. MS 102 and RAN 110, and in particular transceiver 112, communicate via an air interface 104 that includes a downlink and an uplink, wherein the downlink includes at least one downlink traffic channel, a broadcast channel, and at least one downlink signaling channel and the uplink includes at least one uplink traffic channel and at least one uplink signaling channel. Collectively, transceivers 112, 122, controllers 114, 124, application proxies 116, 126, access gateway 130, the elements of IMS 134, application servers 136, 138, and game server 140 are referred to herein as a wireless network 150 and each of transceivers 112, 122, controllers 114, 124, access gateway 130, the elements of IMS 134, application servers 136, 138, and game server 140 comprises an element of the wireless network, that is, a network element.

Each of transceivers 112, 122, controllers 114, 124, application proxies 116, 126, access gateway 130, the elements of IMS 134, application servers 136, 138, and game server 140 includes a processor that is operably coupled to, or associated with, a respective memory device. Each of the processors comprises one or more microprocessors, microcontrollers, digital signal processors (DSPs), combinations thereof or such other devices known to those having ordinary skill in the art. Each memory device comprises one or more memory devices such as a random access memory (RAM), a dynamic random access memory (DRAM), and/or a read only memory (ROM) or equivalents thereof, that stores data and programs that may be executed by the corresponding processor.

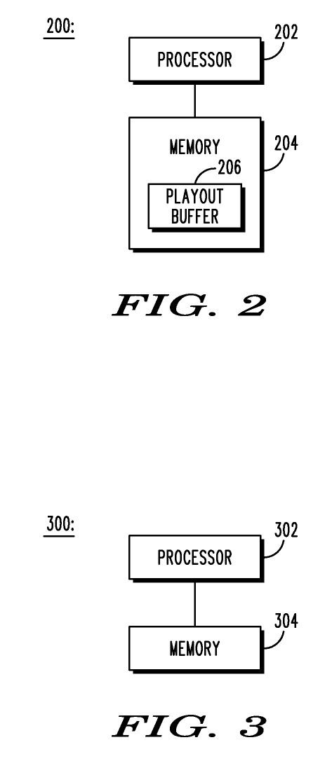

FIG. 2 is a block diagram 200 of an MS, such as MS 102, in accordance with an embodiment of the present invention. As depicted in FIG. 2, the MS includes a processor 202, such as one or more microprocessors, microcontrollers, digital signal processors (DSPs), combinations thereof or such other devices known to those having ordinary skill in the art. The particular operations/functions of processor 202, and thus of the MS, are determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor. The MS further includes a playout buffer 206 that is maintained in the at least one memory device 204 and that stores voice and data received by the MS for subsequent play out to a user of the MS. For example, the MS may receive voice or data at a higher rate than the rate at which the MS is able to play out the voice or data. Accordingly, the voice or data that has been received and decoded but not yet played out is stored in the playout buffer.

FIG. 3 is a block diagram 300 of an element of network 150, such as transceivers 112, 122, controllers 114, 124, application proxies 116, 126, access gateway 130, the elements of IMS 134, application servers 136, 138, and game server 140, in accordance with an embodiment of the present invention. As depicted in FIG. 3, the network element includes a processor 302, such as one or more microprocessors, microcontrollers, digital signal processors (DSPs), combinations thereof or such other devices known to those having ordinary skill in the art. The particular operations/functions of processor 302, and thus of the network element, are determined by an execution of software instructions and routines that are stored in a respective at least one memory device 304 associated with the processor, such as random access memory (RAM), dynamic random access memory (DRAM), and/or read only memory (ROM) or equivalents thereof, that store data and programs that may be executed by the corresponding processor. The at least one memory device 304 of the network element further maintains routing information associated with a cell reselection decision function when such a function is implemented in network 150.

The embodiments of the present invention preferably are implemented within MS 102 and one or more of the elements of network 150, and more particularly with or in software programs and instructions stored in the respective at least one memory device 204, 304 of the MS and the one or more network elements and respectively executed by processors 202 and 302. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the one or more of the elements of network 150 and MS 102. Based on the present disclosure, one skilled in the art will be readily capable of producing and implementing such software and/or hardware without undo experimentation.

Communication system 100 comprises a wideband packet data communication system that employs an Orthogonal Frequency Division Multiplexing (OFDM) modulation scheme for transmitting data over air interface 104. Preferably, communication system 100 is an Orthogonal Frequency Division Multiple (OFDM) communication system, wherein a frequency bandwidth is split into multiple frequency sub-carriers that comprise the physical layer channels over which traffic and signaling channels are transmitted. Further, communication system 100 preferably operates in accordance with the Institute of Electrical and Electronics Engineers (IEEE) 802.21 standards, which standards specify mobile broadband wireless access protocols, including radio system parameters and call processing procedures. However, those who are of ordinary skill in the art realize that communication system 100 may operate in accordance with any wireless telecommunication system employing cell reselections, such as a General Packet Radio Service (GPRS) communication system, a 3GPP2 (Third Generation Partnership Project 2) communication system or a subsequent generation of a 3GPP2 communication system, such as a 3GPP2 Evolution communication system, for example, a CDMA (Code Division Multiple Access) 2000 IXEV-DV communication system, a 3GPP communication system or a subsequent generation of a 3GPP communication system, such as a 3GPP E-UTRA (Evolutionary UMTS Terrestrial Radio Access) communication system, or a Wireless Local Area Network (WLAN) communication system as described by other IEEE 802.xx standards, for example, the 802.11 or 802.16 standards, or any of multiple proposed ultrawideband (UWB) communication systems.

At the level of interconnected networks systems, such as communication system 100, understandings known as protocols have been developed for an exchange of data among multiple users of the networks. The protocols specify the manner of interpreting every data bit of a data packet exchanged across the networks. In order to simplify network designs, several well-known techniques of layering the protocols have been developed. Protocol layering divides the network design into functional layers and then assigns separate protocols to perform each layer's task. By using protocol layering, the protocols are kept simple, each with a few well-defined tasks. The protocols can then be assembled into a useful whole, and individual protocols can be removed or replaced as needed.

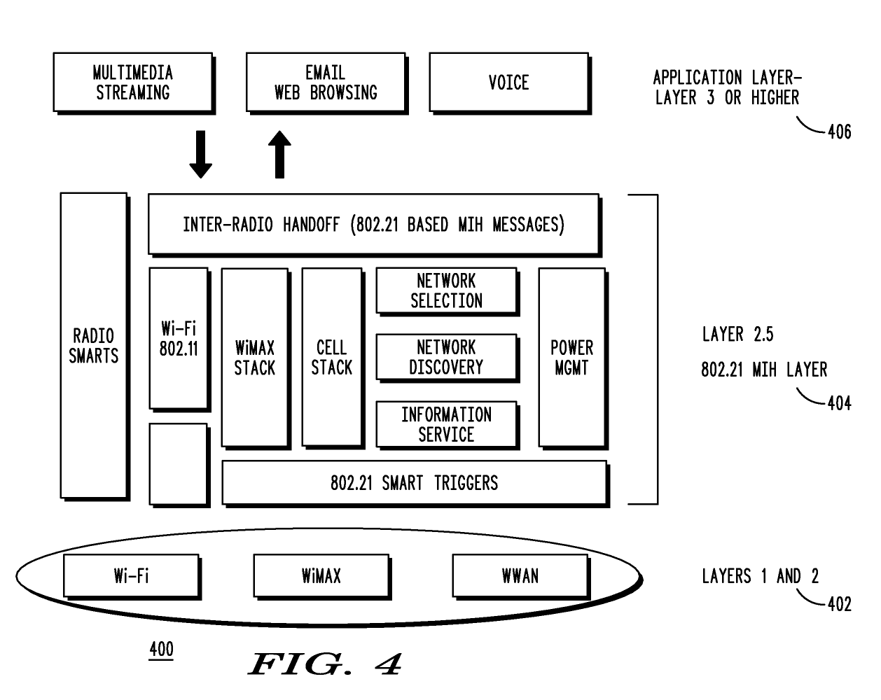

A layered representation of protocols is commonly known as a protocol stack. FIG. 4 is a block diagram of a protocol stack 400 implemented in the one or more elements of network 150 implementing the present invention and in MS 102 in accordance with an embodiment of the present invention. Protocol stack 400 includes multiple layers, which layers include, from highest to lowest, upper layers 406, that is, Layers 3 and higher, which upper layers include an Application Layer, a Media Independent Handover (MIH) Layer 404, also known as Layer 2.5, and lower layers 402, that is, Layers 1 and 2, which layers include a Link Layer, a Medium Access Control (MAC) Sub-layer, and a Physical Layer. Each layer of protocol stack 400, other then the Physical Layer, is implemented in the processor of the implementing network element or MS and operates based on instructions stored in the corresponding memory device of the network element or MS.

The lower layers 402 of protocol stack 400, that is, the Link Layer, MAC Sub-layer, and Physical Layer, includes the network hardware and a physical medium for the transportation of data and further provides the functional and procedural means to transfer data between network entities and to detect and possibly correct errors that may occur in the Physical Layer. The next layer up, that is, MIH Layer 404, is responsible for delivering data across a series of different physical networks that interconnect a source of the data and a destination for the data. Routing protocols, end-to-end data flow management across interconnected network systems, a selection of a network in which to operate when there are multiple overlapping networks, handoff decisions, and power management are among the functionality performed by MIH Layer 404. Above MIH Layer 404 are upper layers 406, which upper layers include an Application Layer that contains protocols that implement user-level applications, such as file transfer, multimedia, streaming, email delivery, web browsing, and voice telephony.

When MS 102 is actively engaged in a communication session and roams through communication system 100, the MS may experience deterioration in radio frequency (RF) signal conditions or congestion conditions with respect to the communication services provided to the MS by a source RAN 110 and transceiver 112 serving the MS. As a result, the MS, or network 150, may decide that the MS should perform a cell reselection. During cell reselection, the MS abandons a source cell, that is, cell serviced by source RAN 110 and source transceiver 112, and moves to a neighboring, or target, cell, such as a cell serviced by a target RAN 120 and a target transceiver 122, terminating a communication link with the source RAN and establishing a communication link with the target RAN. A decision to handoff the communication session is made by a cell reselection decision function, typically implemented in MIH Layer 404 or the Link Layer or MAC Sub-Layer of lower layers 402, of an element of network 150 or by MS 102. In the prior art, a timing of the cell reselection is merely based on measured channel conditions or other lower layer 402, that is, Physical Layer, Link Layer, and/or MAC Sub-layer, information and, as a result, may occur at an inopportune time with respect to an application being executed by the MS. Therefore, communication system 100 provides for the cell reselection decision function to consider upper layer 406 information, such as Application Layer information, in determining when to execute a cell reselection.

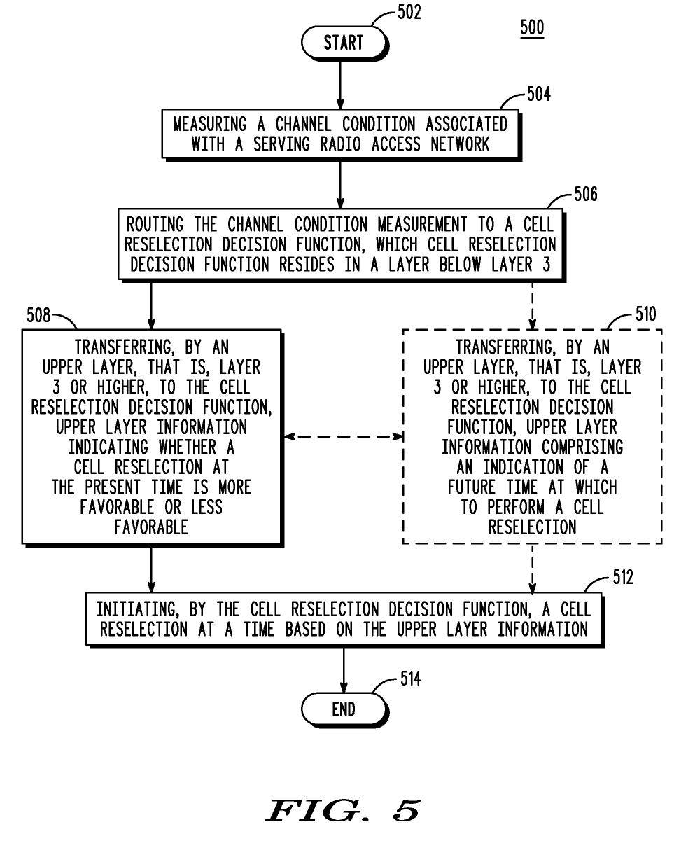

Referring now to FIG. 5, a logic flow diagram 500 is provided that depicts a selecting of a timing of a cell reselection by communication system 100 in accordance with an embodiment of the present invention. Logic flow 500 begins (502) when an MS, such as MS 102, measures (504) a channel condition associated with a signal received from a serving RAN, such as RAN 110. For example, the MS may measure a received signal power, a signal-to-noise ratio, a carrier-to-interference ratio, a carrier power-to-noise power ratio, a bit error rate, or a frame error rate associated with a received signal. One of ordinary skill in the art realizes that many parameters may be measured in determining a channel condition and that any such parameter may be used herein without departing from the spirit and scope of the present invention. The channel condition measurement is then routed (506) to a cell reselection decision function, that is, the functionality that determines whether to perform a cell reselection.

In one embodiment of the present invention, the cell reselection decision function may be implemented in the MIH Layer 404 or the lower layers 402 of the MS. In another embodiment of the present invention, the cell reselection decision function may be implemented in the MIH Layer 404 or the lower layers 402 of a network element, such as an element of network 150. In the latter instance, MS 102 may convey the detected channel conditions to the cell reselection decision functionality of the network via an uplink of an air interface of the serving RAN, such as air interface 104.

The cell reselection decision function further receives from upper layer 406, preferably from the Application Layer, and upper layer 406 transfers (508) to the cell reselection decision function, upper layer information, preferably Application Layer information, indicating whether a cell reselection at the present time, that is, this instant in time, is more favorable or less favorable. Instead, or in addition if a cell reselection at the present time is less favorable, the cell reselection decision function may receive from upper layer 406 and preferably from the Application Layer, and upper layer 406 may transfer (510) to the cell reselection decision function, upper layer information, preferably Application Layer information, comprising an indication of a future time at which to perform a cell reselection. For example, the upper layer information may identify a delay prior to initiating the cell reselection, such as a period of time to wait (a waiting period) or a quantity of data, such as a number of bytes, that must be transferred and/or received before performing a cell reselection. In response to receiving the upper layer information from upper layers 406, the cell reselection decision function then initiates (512) a cell reselection at a time based on the upper layer information received from upper layers 406 and logic flow 500 ends (514).

Preferably, upper layers 406, and preferably the Application Layer, conveys the upper layer information to the cell reselection decision function in a modified version of one or more primitives of multiple primitives that have been defined for communications between upper layers 406, and more particularly an Application Layer, and MIH Layer 404, which primitive(s) are modified to include upper layer information concerning a favorability of performing a handoff. For example, the modified primitive may comprise a modified version of an IEEE 802.21 MIH Command Service, which commands are modified to include data supporting, that is, indicating whether to perform, an immediate or delayed execution of a command. More particularly, a new data field, that is, a sub-type field, may be added to an MIH_Handover_Init primitive that identifies a sub-command type, such as an immediate or a delayed execution of a command, and more particularly of a handover command. The primitive may be further modified to include an additional data field that indicates a length of a delay before executing the command, that is, the handover command. More particularly, the additional data field may notify the cell reselection decision function how long the cell reselection decision function should delay executing the command after receiving the command.

When the cell reselection decision function resides in the MS and the upper layer 406 information is sourced from an upper layer 406 of the MS, then the upper layer routes the upper layer information to the MIH Layer 404 or the lower layers 402 of the MS. Similarly, when the cell reselection decision function is implemented in the network element and the upper layer 406 information is sourced from an upper layer 406 of the same, or a different, network element, then the upper layer 406 sourcing the upper layer information routes the upper layer information to the MIH Layer 404 or the lower layers 402 of the network element implementing the cell reselection decision function.

When the cell reselection decision function resides in the MS and the upper layer information is sourced from an upper layer 406 of the network element, then the upper layer 406 of the network element routes the upper layer information to the MIH Layer 404 or the lower layer 402, whichever layer corresponds to the layer of the MS implementing the cell reselection decision function, of the network element. The MIH Layer 404 or lower layer 402, which ever is appropriate, of the network element then establishes a peer-to-peer protocol connection with the corresponding layer of the MS and conveys the upper layer information to the cell reselection decision functionality of the MS.

Similarly, when the cell reselection decision function resides in the network element and the upper layer information is sourced from an upper layer 406 of the MS, then the upper layer 406 of the MS routes the upper layer information to the MIH Layer 404 or the lower layer 402, whichever layer corresponds to the layer of the network element implementing the cell reselection decision function, of the MS. The MIH Layer 404 or lower layer 402, whichever is appropriate, of the MS then establishes a peer-to-peer protocol connection with the corresponding layer of the network element implementing the cell reselection decision function and conveys the upper layer information to the cell reselection decision functionality of the network element.

The upper layer information routed to the cell reselection decision function comprises upper layer information that assists the cell reselection decision function in determining an optimal time to execute a cell reselection. In one embodiment of the present invention, the upper layers 406 may determine whether a cell reselection is more favorable or less favorable information based on a status of a data transfer, such as a file transfer, a movie transfer, or a song transfer. When the Application Layer determines the file, movie or song transfer is almost complete, for example, determines a file size and a quantity of data already transferred, then the upper layer information may indicate that a cell reselection is less favorable at this instant. By way of another example, when the Application Layer determines that a talk spurt is almost completed, for example, by detecting that the user has released a push-to-talk button but the voice or voice data transfer is not yet complete, for example, by detecting whether any data remains in a voice buffer of the MS, then the upper layer information may indicate that a cell reselection is less favorable at this instant. In addition, the Application Layer may calculate a quantity of time remaining, or a quantity of data, such as bytes, remaining to be transferred, before the voice or voice data transfer is complete. The upper layer information then may further include an identification of a delay in the a cell reselection, that is, an indication that a cell reselection is more favorable after waiting for a period of time associated with the calculated remaining transfer time or after waiting for a transfer of the quantity of data remaining to be transferred.

In another embodiment of the present invention, the upper layers 406 may determine whether a cell reselection is more favorable or less favorable based on a status of a game executed by a user of the MS or based on a geographical location of another participant in a game, such as a proximity of the another participant to the user of the MS. For example, when a user of the MS is engaged in a video game via an air interface and upper layers 406 determine that an action by the user is immediate, for example, when a ball is near a goal, or when the user is engaged in an activity wherein a delayed response may cause the user to miss an opportunity to gain, or may cause the user to lose, a large number of points or for a player controlled by the user to die, for example, when the user is engaged in heavy combat or a tricky driving scenario, or when the user is engaged in a multi-user video game with another remote gamer and the game involves motion or visual activity, then the upper layers may determine, and indicate to the cell reselection decision function, that a cell reselection is less favorable at this instant. By way of another example, when a user of the MS is engaged in a multi-user game and another participant in the game is nearby, then upper layers 406 may determine, and indicate to the cell reselection decision function, that a cell reselection is less favorable at this instant. A determination of whether the another participant in the game is nearby may be based on whether the user of the MS is able to communicate with a MS used by the another participant via a short distance wireless technology, such as Bluetooth or an Infrared technology, indicating that the another participant is nearby, or may be determined by an element of network 150, such as RAN 110, based on a determined location of each of the user's MS and the another participant's MS. One of ordinary skill in the art realizes that many methods exist for determining a location of an MS, and any such method may be used herein without departing from the spirit and scope of the present invention.

In yet another embodiment of the present invention, when the MS is engaged in a multi-participant communication session, the upper layers 406 may determine whether a cell reselection is more favorable or less favorable based on a status of the communication session, such as whether one or more participants in the communication session other than the user of the MS are processing a handoff (which would be known by an application layer of a network element, such as a RAN serving multiple network participants or a RAN of multiple RANs that are serving multiple participants and that are in communication with each other), whether the MS is on call hold, whether the MS, or a target MS, is ringing but has not yet answered the call, or whether the MS has been transferred to voicemail. For example, an indication that one or more other participants in the call are processing a handoff, that the MS is on call hold, that the MS, or a target MS, is ringing but has not yet answered the call, or that the MS has been transferred to voicemail, may indicate that a cell reselection is more favorable at this instant.

In still another embodiment of the present invention, the upper layers 406 may determine whether a cell reselection is more favorable or less favorable based on a status of a playout buffer 206 of a target MS. When the playout buffer is full or maintains a significant quantity of data, then upper layers 406 may determine, and indicate to the cell reselection decision function, that a cell reselection is more favorable at this instant. For example, upper layers 406 may determine that a cell reselection is more favorable at this instant by comparing a quantity data maintained in the buffer to a buffer threshold, and when the quantity of data exceeds the threshold then the upper layers may determine that a cell reselection is more favorable at this instant. For example, the upper layers 406 may determine a quantity data maintained in the playout buffer based on feedback concerning the status of the playout buffer provided by the target MS to network 150. By way of another example, a network element, such as a RAN serving the target MS, may be aware of a rate at which the target MS plays out data or voice to the target MS. For example, such information may be included in a profile of the MS that is maintained in an MS profile database in a Home Location Register (HLR) or an HSS associated with a home network of the MS. The target RAN may then retrieve such information when accessing the profile of the target MS when the call is set up. By way of another example, the playout capabilities of the target MS may be known based on brand, model, and/or other such information associated with the target MS, which information is obtained by the target RAN from the database maintaining the profile of the target MS when the call is set up. The target RAN is further aware of a rate at which data is being transferred to the target MS via an air interface of the target RAN. Based on a comparison of the playout rate of the target MS and the rate at which data is being transferred to the target MS via an air interface of the target RAN, the target RAN is able to determine a quantity of data maintained by the playout buffer, that is, a depth of the playout buffer. Such upper layer information then may be sourced to a cell reselection decision function by the upper layers 406, preferably the Application Layer, of the target RAN.

In yet another embodiment of the present invention, the upper layers 406 may determine whether a cell reselection is more favorable or less favorable at the instant time based on a prioritization of multiple applications being executed by an Application Layer of the MS or being executed by an Application Layer of each MS of multiple MSs. For example, each application of the multiple applications may have a different time critical aspect to the data being transferred with respect to the application. For example, a data transfer associated with a Voice of Internet Protocol (VoIP) application is highly time sensitive as breaks in a spoken voice are undesirable, while a data transfer associated with an email application is time deferrable, that is, has a low sensitivity to a time of transfer, and may be deferred with little impact on a recipient of the data. Typically, the more time critical application would have a higher priority, so if a VoIP application is running concurrent with an email application then the upper layers 406 may prioritize the VoIP application and determine that a cell reselection is less favorable at the instant time. On the other hand, if the upper layers 406 prioritize the email application, then the upper layers may determine that a transfer of the email data may be deferred and that a cell reselection is more favorable at the instant time. By way of another example, when one MS of the multiple MSs is executing a VoIP application and another MS of the multiple MSs is executing an email application, the upper layers 406 of an element of network 150 may determine that the instant time is a favorable time for the MS executing the VoIP application to perform a cell reselection and may determine to defer the execution of a cell reselection by the MS executing the email application. By way of yet another example, of one of multiple MSs is less flexible with respect to when it may execute a cell reselection, for example, as described above, is executing a more time sensitive application, or is a higher priority MS, such as an emergency service MS or is subscribed to a subscriber plan that accords the MS with a higher priority with respect to cell reselections, then the instant time for a cell reselection may be indicated as being more favorable for the less flexible or higher priority MS and as being less favorable for more flexible or lower priority MS.

In still another embodiment of the present invention, the upper layers 406 of an element of network 150 may attempt to coordinate cell reselections by multiple MSs that are members of a talkgroup. For example, the upper layers 406 of an element of network 150 may instruct a RAN serving multiple members of the group to broadcast a message concerning an optimal time to execute a cell reselection. For example, the message may instruct each member of the group to perform the cell reselection now if the member is considering a cell reselection, or perform the cell reselection at a defined future time (for example, 100 milliseconds (ms) from now) if the member is considering a cell reselection. By way of another example, if both a transmitting, or talking, MS and a receiving, or listening, MS in a communication session are considering, or are being considered for, a cell reselection, the upper layers 406 of an element of network 150 may schedule a cell reselection by the transmitting MS to slightly precede a cell reselection by the receiving MS. Preferably the timing of the cell reselections would be such that any pause in a transfer of data caused by the cell reselection executed by the transmitting MS would be coordinated with a pause in a transfer of data caused by the cell reselection executed by the receiving MS. That is, the timing of the cell reselections would attempt to avoid the receiving MS experiencing two pauses in a transfer of data, one due to the cell reselection by the transmitting MS and the other due to the cell reselection executed by the receiving MS.

By transferring cell reselection decision information from an upper layer at least as high as Layer 3, and preferably an Application Layer, to a cell reselection decision function residing in a layer lower than Layer 3, and then initiating, by the cell reselection decision function, a cell reselection based on the transferred information, communication system 100 is able to minimize an impact of a cell reselection on an application being executed by an associated MS. By minimizing the impact of a cell reselection on an application being executed by an associated MS, communication system 100 is able to reduce potential user dissatisfaction due to interruptions in the execution of the application due to cell reselections.

In one embodiment of the present invention, the transferred information may comprise an indication of whether a present time is a more favorable time or a less favorable time for a cell reselection. A determination of whether a present time is a more favorable time or a less favorable time for a cell reselection may be based on upper layer considerations such as a status of a data transfer, a status of a game executed by a user of the MS, a geographical location of another participant in a game being executed by a user of the MS, a status of a communication session involving the MS, a status of a playout buffer, a time sensitivity of an application executed by the MS, a prioritization of a plurality of applications executed by the MS, a coordination of cell reselections by the members of a talkgroup that includes the MS, and a coordination of a cell reselection by each of a transmitting MS and a receiving MS. In another embodiment of the present invention, the transferred information may additionally, or instead, comprise an indication of a future time at which to perform a cell reselection, such as a delay corresponding to a waiting period or a quantity of data to be transferred or received before performing the cell reselection.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for selecting a timing of a cell reselection in association with a mobile station, the method comprising:
transferring, by a layer at least as high as Layer 3 to a cell reselection decision function residing in a layer lower than Layer 3, information indicating whether a present time is a more favorable time or a less favorable time for a cell reselection; and
initiating, by the cell reselection decision function, a cell reselection at a time based on the information received from the layer at least as high as Layer 3.

2. The method of claim 1, wherein the layer at least as high as Layer 3 is an Application Layer.

3. The method of claim 1, wherein transferring comprises transferring a Media Independent Handover Command Service indicating an immediate or a delayed execution of a handover.

4. The method of claim 1, wherein transferring comprises transferring a MIH_Handover_Init primitive indicating an immediate or a delayed execution of a handover.

5. The method of claim 1, further comprising determining, by the layer at least as high as Layer 3, whether the present time is a more favorable time or a less favorable time for a cell reselection based on a status of a data transfer.

6. The method of claim 5, further comprising calculating, by the layer at least as high as Layer 3, one or more of a quantity of time remaining before the data transfer is complete and a quantity of data remaining to be transferred before the data transfer is complete and wherein transferring comprises transferring an indication that a cell reselection is more favorable after waiting for one or more of a period of time associated with the calculated remaining transfer time and a transfer of the quantity of data remaining to be transferred.

7. The method of claim 1, further comprising determining, by the layer at least as high as Layer 3, whether the present time is a more favorable time or a less favorable time for a cell reselection based on one or more of:
a status of a game executed by a user of the mobile station,
a geographical location of another participant in a game being executed by a user of the mobile station,
a status of a communication session involving the mobile station,
a status of a playout buffer,
a time sensitivity of an application executed by the mobile station,
a prioritization of a plurality of applications being executed by the mobile station, a coordination of cell reselections by members of a talkgroup that includes the mobile station, and
a coordination of a cell reselection by each of a transmitting mobile station and a receiving mobile station.

8. A method for selecting a timing of a cell reselection comprising:
transferring, by a layer at least as high as Layer 3 to a cell reselection decision function residing in a layer lower than Layer 3, information comprising an indication of a future time at which to perform a cell reselection; and
initiating, by the cell reselection decision function, a cell reselection at a time based on the information received from the layer at least as high as Layer 3.

9. The method of claim 8, wherein the layer at least as high as Layer 3 is an Application Layer.

10. The method of claim 8, wherein transferring comprises transferring information identifying one or more of a waiting period before performing a cell reselection and a quantity of data that must be one or more of transferred or received before performing a cell reselection.

11. The method of claim 8, wherein transferring comprises transferring a Media Independent Handover Command Service indicating a length of a delay before executing a handover.

12. The method of claim 8, wherein transferring comprises transferring a MIH_Handover_Init primitive indicating a length of a delay before executing a handover.

13. An apparatus comprising a processor that is configured to transfer, by a layer at least as high as Layer 3 to a cell reselection decision function residing in a layer lower than Layer 3, information indicating whether a present time is a more favorable time or a less favorable time for a cell reselection and to initiate, by the cell reselection decision function, a cell reselection at a time based on the information received from the layer at least as high as Layer 3.

14. The apparatus of claim 13, wherein the processor is configured to transfer, by the layer at least as high as Layer 3 to the cell reselection decision function, a Media Independent Handover Command Service indicating an immediate or a delayed execution of a handover.

15. The apparatus of claim 13, wherein the processor is configured to transfer, by the layer at least as high as Layer 3 to the cell reselection decision function, a MIH_Handover_Init primitive indicating an immediate or a delayed execution of a handover.

16. The apparatus of claim 13, wherein the processor is configured to determine, by the layer at least as high as Layer 3, whether the present time is a more favorable time or a less favorable time for a cell reselection based on a status of a data transfer.

17. The apparatus of claim 16, wherein the processor is configured to calculate, by the layer at least as high as Layer 3, one or more of a quantity of time remaining before the data transfer is complete or a quantity of data remaining to be transferred before the data transfer is complete and wherein the processor is further configured to transfer, from the layer at least as high as Layer 3 to the cell reselection decision function, an indication that a cell reselection is more favorable after waiting for one or more of a period of time associated with the calculated remaining transfer time and a transfer of the quantity of data remaining to be transferred.

18. The apparatus of claim 13, wherein the processor is configured to determine, by the layer at least as high as Layer 3, whether the present time is a more favorable time or a less favorable time for a cell reselection based on one or more of:
a status of a game executed by a user of the mobile station,
a proximity of another participant in a game being executed by a user of the mobile station,
a status of a communication session involving the mobile station,
a time sensitivity of an application executed by the mobile station, and
a prioritization of a plurality of applications being executed by the mobile station.

19. A mobile station comprising the apparatus of claim 13.

20. A network element comprising the apparatus of claim 13.

21. An apparatus comprising a processor that is configured to transfer, by a layer at least as high as Layer 3 to a cell reselection decision function residing in a layer lower than Layer 3, information comprising an indication of a future time at which to perform a cell reselection and initiate, by the cell reselection decision function, a cell reselection at a time based on the information received from the layer at least as high as Layer 3.

22. The mobile station of claim 21, wherein the processor is configured to transfer information comprising an indication of a future time by transferring one or more of information identifying a waiting period before performing a cell reselection and information identifying a quantity of data that must be one or more of transferred or received before performing a cell reselection.

23. The mobile station of claim 21, wherein the processor is configured to transfer information comprising an indication of a future time by transferring a Media Independent Handover Command Service indicating a length of a delay before executing a handover.

24. The mobile station of claim 21, wherein the processor is configured to transfer information comprising an indication of a future time by transferring a MIH_Handover_Init primitive indicating a length of a delay before executing a handover.

25. A mobile station comprising the apparatus of claim 21.

26. A network element comprising the apparatus of claim 21.
